(19) United States
(12) Patent Application Publication
(10) Pub. No.: US 2026/0128944 A1
(43) Pub. Date: May 7, 2026

(54) METHOD FOR REARRANGING EDGE COMPUTING-LINKED CONTEXT

(71) Applicant: Samsung Electronics Co., Ltd., Suwon-si, Gyeonggi-do (KR)

(72) Inventors: Cheolung LEE, Suwon-si (KR); Hyesung KIM, Suwon-si (KR)

(21) Appl. No.: 19/117,931

(22) PCT Filed: Oct. 4, 2023
(86) PCT No.: PCT/KR2023/015194

§ 371 Date: Apr. 2, 2025

(30) Foreign Application Priority Data
Oct. 4, 2022 (KR) 10-2022-0126325

(51) Int. Cl. H04L 41/0803; H04L 41/12

(52) U.S. Cl. CPC H04L 41/0803; H04L 41/12

(57) ABSTRACT

The present disclosure relates to a 5G or 6G communication system for supporting higher data transmission rates. According to various embodiments of the present disclosure, provided is an operating method of an EAS in a wireless communication system, comprising the steps of: transmitting, to a CCF, a federated EAS API list request message; receiving, from an EES, a response message to the federated EAS API list request message including context information of a federated EAS; and rearranging federated EAS context on the basis of the context information.

### TECHNICAL FIELD

The disclosure generally relate to wireless communication systems, and more specifically, to a device and method for providing an edge computing service in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DETAILED DESCRIPTION OF THE INVENTION

### Technical Problem

Based on the above discussions, the disclosure provides a method for a federated edge computing context relocation in a wireless communication system.

### Technical Solution

According to various embodiments of the disclosure, provided is an operating method of an S-EAS in a wireless communication system, comprising the processes of transmitting, to a CCF, a federated EAS API list request message, receiving, from the CCF, a response message to the federated EAS API list request message including federated EAS context information, and relocating the federated EAS context based on the context information.

### Advantageous Effects

The device and method according to various embodiments of the disclosure may provide a device and method for providing an edge computing service in a wireless communication system.

Effects obtainable from the disclosure are not limited to the above-mentioned effects, and other effects not mentioned may be apparent to one of ordinary skill in the art from the following description.

### BRIEF DESCRIPTION OF DRAWINGS

FIG. 1 illustrates a federated context relocation method using a common API framework (CAPIF) CORE FUNCTION (hereinafter, CCF) to maintain a federated EAS service session in another edge data network (EDN) when an application context relocation (ACR) occurs due to the mobility of a UE in a wireless communication system according to various embodiments of the disclosure.

FIG. 2 illustrates an example in which in a wireless communication system according to various embodiments of the disclosure, a CCF sets each API of a target EAS (hereinafter, T-EAS) supporting a federated EAS, and provides a federated EAS(F) API list of a source EAS (hereinafter, S-EAS) so that the S-EAS provides a corresponding context to the S-EES for the S-EES to perform an ACR procedure of a plurality of federated EASs.

FIG. 3 illustrates an example in which in a wireless communication system according to various embodiments of the disclosure, a CCF receives a federated EAS API list from an S-EES or an S-EAS and performs a procedure of transmitting a federated API list to a T-EAS.

FIG. 4 illustrates a structure of a network device according to various embodiments of the disclosure.

### MODE FOR CARRYING OUT THE INVENTION

The terms as used herein are provided merely to describe some embodiments thereof, but not to limit the scope of other embodiments of the present disclosure. It is to be understood that the singular forms “a,” “an,” and “the” include plural references unless the context clearly dictates otherwise. The terms including technical and scientific terms used herein have the same meaning as commonly understood by one of ordinary skill in the art to which the embodiments of the present disclosure belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein. In some cases, the terms defined herein may be interpreted to exclude embodiments of the present disclosure.

Methods described below in connection with embodiments are based on hardware. However, embodiments of the disclosure encompass technology using both hardware and software and thus do not exclude software-based methods.

As used herein, terms denoting signals, terms denoting channels, terms denoting control information, terms denoting network entities, terms denoting data stored in network entities, terms denoting messages transmitted/received between entities, and terms denoting device components are provided as an example for ease of description. The disclosure is not limited to the terms, and other terms equivalent in technical concept may also be used.

Further, although the disclosure describes various embodiments using terms used in some communication standards (e.g., 3rd generation partnership project (3GPP)), this is merely an example for description. Various embodiments of the disclosure may be easily modified and applied in other communication systems.

In order to meet the demand for wireless data traffic soaring since the 4G communication system came to the market, there are ongoing efforts to develop enhanced 5G communication systems or pre-5G communication systems. For the reasons, the 5G communication system or pre-5G communication system is called the beyond 4G network communication system or post long term evolution (LTE) system.

For higher data transmit rates, 5G communication systems are considered to be implemented on ultra-high frequency bands (mmWave), such as, e.g., 60 GHz. To mitigate pathloss on the ultra-high frequency band and increase the reach of radio waves, the following techniques are taken into account for the 5G communication system: beamforming, massive multi-input multi-output (MIMO), full dimensional MIMO (FD-MIMO), array antenna, analog beamforming, and large scale antenna.

Also being developed are various technologies for the 5G communication system to have an enhanced network, such as evolved or advanced small cell, cloud radio access network (cloud RAN), ultra-dense network, device-to-device (D2D) communication, wireless backhaul, moving network, cooperative communication, coordinated multi-point (COMP), and interference cancellation.

There are also other various schemes under development for the 5G system including, e.g., hybrid FSK and QAM modulation (FQAM) and sliding window superposition coding (SWSC), which are advanced coding modulation (ACM) schemes, and filter bank multi-carrier (FBMC), non-orthogonal multiple access (NOMA) and sparse code multiple access (SCMA), which are advanced access schemes.

Meanwhile, the 3GPP, which is in charge of cellular mobile communication standardization, has named the new core network structure 5G core (5GC) and standardized the same to promote the evolution from the legacy 4G LTE system to the 5G system.

5GC supports the following differentiated functions as compared to the evolved packet core (EPC), which is the legacy network core for 4G.

First, 5GC adopts the network slicing function. 5GC is required to support various types of user equipment (UE) and services. For example, such services may include enhanced mobile broadband (eMBB), ultra-reliable low latency communications (URLLC), and massive machine-type communications (mMTC). These UEs/services have different requirements for the core network. For example, the eMBB service requires a high data rate while the URLLC service requires high stability and low latency. Network slicing is technology proposed to meet such various requirements.

Network slicing is a method for creating multiple logical networks by virtualizing one physical network, and the network slice instances (NSIs) may have different characteristics. Therefore, various service requirements may be met by allowing each NSI to have a network function (NF) suited for its characteristics. Various 5G services may be efficiently supported by allocating an NSI meeting required service characteristics for each UE.

Second, 5GC may seamlessly support the network virtualization paradigm by separating the mobility management function and the session management function. In legacy 4G LTE, all UEs may receive services over the network through signaling exchange with a single core device called the mobility management entity (MME) in charge of registration, authentication, mobility management and session management functions. However, in 5G, the number of UEs explosively increases and mobility and traffic/session characteristics that need to be supported according to the type of UE are subdivided. Resultantly, if all functions are supported by a single device, such as MME, the scalability of adding entities for each required function may decrease. Accordingly, various functions are under development based on a structure that separates the mobility management function and the session management function to enhance the scalability in terms of function/implementation complexity of the core equipment in charge of the control plane and the signaling load.

Meanwhile, edge computing systems are recently emerging. In the edge computing system, a user equipment (UE) may establish a data connection to an edge data network (EDN), located nearby to use a low-latency or broadband service, to receive an edge computing service. The edge computing service may be provided through an edge application server (EAS) driven in an edge computing platform or an edge hosting environment operated by an edge enabler server (EES) of a specific edge data network. In other words, the UE may receive an edge computing service from the edge application server (EAS) located closest to the area where the UE is located.

The disclosure provides a method and device for searching for and obtaining an edge application server (EAS) capable of using a function of an application federated with an edge application server (EAS) when a UE moves.

The disclosure also provides an operation and device for indicating whether information for federated edge computing service-related servers previously connected when an edge application server providing a federated function is re-executed is valid and whether it is reusable.

The disclosure also provides a method for searching for a valid edge application server when failing to discover an edge application server for providing a federated function.

The disclosure also provides a federated context processing method for providing an edge application server with federated edge application server information (edge application server profile, e.g., edge application server address/service area/status/service KPI et al.) and an element (e.g., federated EAS indicator, available application programming interfaces (APIs)) capable of identifying a service of an available federated application server and an edge application server providing a federated function by an application enabler server.

The disclosure also provides a method for minimizing UE signaling for re-obtaining edge application information and UE's edge computing configuration information when an update for the information occurs.

According to an embodiment of the disclosure, a method performed by an edge enabler server (EES) in a wireless communication system supporting edge computing includes a process in which the EES receives a registration request message including a federated edge application server identifier from an edge application server (EAS), a process of providing federated EAS information valid for the EAS to the EAS, a process in which the EES selects a method for providing the EAS with EAS information capable of using the federated EAS, and a process of performing an operation based on the selected method for providing the federated EAS information.

Further, according to an embodiment of the disclosure, an edge enabler server (EES) in a wireless communication system supporting edge computing includes a transceiver and a processor configured to receive, through the transceiver, a registration request message including a context of a federated edge application server not configured in the EES, select a method for providing federated EAS information for the EAS, and perform an operation based on the selected providing method to provide the EAS information to the UE.

The disclosure proposes a context relocation method for continuously providing a federated service of an edge application server when a UE moves. Proposed is a method for searching for an edge application server providing a federated function. Proposed is a method for requesting another edge data network to search when there is no edge application server providing a valid federated function in the same edge data network. Proposed is a method for an edge computing service entity to identify an edge application server providing a federated function. Proposed is a method for storing and providing a valid federated edge application server list. The corresponding context may occur according to the locational distributed deployment characteristics of edge computing services and the mobility of the UE.

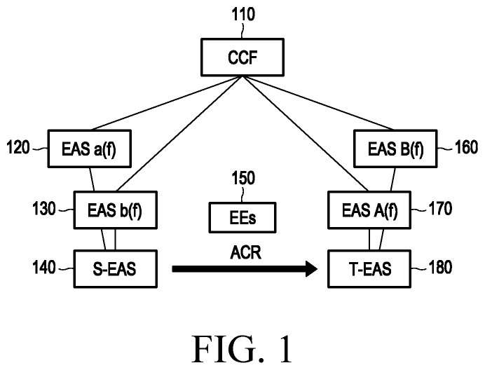

FIG. 1 illustrates a federated context relocation method using a common API framework core function (CCF) in a wireless communication system according to an embodiment of the disclosure.

Referring to FIG. 1, a wireless communication system includes a common API framework core function (CCF) 110, a first EAS (EAS a(f)) 120, a second EAS (EAS b(f)) 130, a source EAS (S-EAS) 140, an edge enabler server (EES) 150, a third EAS (EAS B(f)) 160, a fourth EAS (EAS A(f)) 170, and a target EAS (T-EAS) 180. According to an embodiment, the first EAS 120 and the second EAS 130 may be a plurality of EASs related with the S-EAS 140 and federated (or bundled). According to an embodiment, the third EAS 160 and the fourth EAS 170 may be a plurality of EASs related with the T-EAS 180 and federated (or bundled).

FIG. 1 illustrates a federated context relocation method using the CCF 110 to maintain a federated EAS service session in another edge data network (EDN) when an application context relocation (ACR) from the S-EAS 140 to the T-EAS 180 occurs due to the mobility of the user equipment (or UE) in the wireless communication system.

The CCF 110 is a network function that receives an API list from an edge application server (EAS) that provides an application programming interface (API) and provides an API caller with necessary API information. According to an embodiment, the CCF 110 may configure an EAS(f) API of the federated (or bundled) EAS and include an API list in the S-EES 150, and may transmit a message requesting an ACR. According to an embodiment, the CCF 110 transmits the API list to the S-EES 150 through the S-EAS 140 to provide a method for the S-EES 150 to relocate the API list of all EAS(f)s.

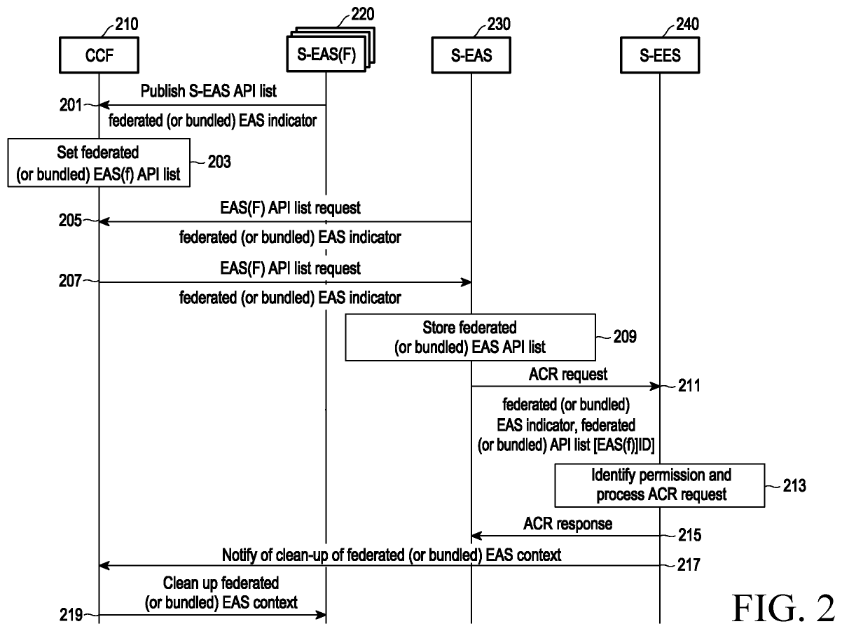

FIG. 2 illustrates an example in which an S-EAS provides an S-EAS(F) API list to an S-EES and the S-EES performs an ACR procedure of a plurality of federated EASs in a wireless communication system according to an embodiment of the disclosure.

The S-EAS(f) may be a plurality of EASs related with the S-EAS 230 and federated (or bundled). In operation 201, the S-EAS(f) may transmit a message for publishing an S-EAS API list to the CCF 210. The message for publishing may include a federated (or bundled) EAS indicator.

In operation 203, the CCF 210 may set an EAS(F) API list that the S-EAS 230 may call. An S-EAS(F) API list may be provided to the CCF 210, including the fed EAS(F) API list of the S-EAS 230. The CCF 210 may receive and set an API list of the SEAS(F) related to all S-EASs from the S-EAS(F) 220.

In operation 205, the S-EAS 230 may request API lists of EAS(F)s including a federated (or bundled) indicator, from the CCF 210. In operation 207, the CCF 210 may include an EAS(F) list corresponding to the federated (or bundled) indicator and transmit it to the S-EAS 230 in a response message.

In operation 209, the S-EAS 230 may store the federated EAS API list provided from the CCF 210.

In operation 211, the S-EAS 230 may transmit an ACR request message including a federated (or bundled) EAS indicator, a federated (or bundled) EAS API list, and an EAS(f) ID to the S-EES 240.

In operation 213, the S-EES 240 may perform an authentication procedure on the ACR request and perform an ACR on each EAS(F). The ACR procedure may use all ACR scenarios determined by the EAS and the EES.

In operation 215, the S-EES 240 may transmit a response message to the ACR request message to the S-EAS 230.

In operation 217, the S-EES 240 may transmit a clean-up notification message to the CCF 210 to remove all contexts remaining in the S-EAS(F) upon success of the ACR.

In operation 219, the CCF 210 may transmit a clean-up message for all S-EAS(F)s corresponding to the notification message received from the S-EES 240.

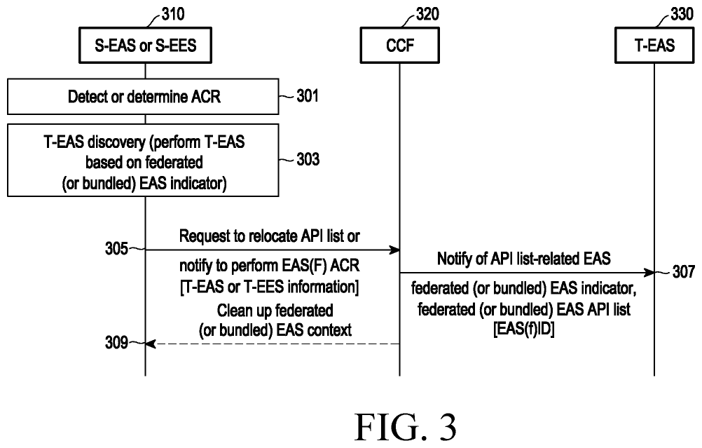

FIG. 3 illustrates an example in which in a wireless communication system according to an embodiment of the disclosure, a CCF receives a federated EAS API list from an S-EES or an S-EAS and performs a procedure of transmitting a federated API list to a T-EAS.

The CCF 320 may set an EAS(F) API list that the S-EAS 310 may call. An S-EAS(F) API list may be provided to the CCF 320 including a federated (or bundled) EAS(F) API list of the S-EAS 310. The CCF 320 may receive and set an API list of the S-EAS(F) related to all S-EASs from the S-EAS(F).

When the S-EAS 310 sends a request for API lists of EAS(F)s including the federated EAS indicator to the CCF 320, the CCF 320 may include an EAS(F) list corresponding to the corresponding indicator and transmit it to the S-EAS 310 in a response message.

In operation 301, the S-EAS or S-EES 310 may detect an ACR or determine to perform the ACR.

In operation 303, the S-EAS or S-EES 310 may perform T-EAS discovery based on the federated (or bundled) EAS indicator. The federated EAS indicator may be included in the T-EES retrieve and T-EAS discovery request message for T-EAS discovery.

In operation 305, the S-EAS or S-EES 310 may include T-EAS or T-EES information in the API list location request message or the EAS(F)s ACR performance notification message and transmit it to the CCF 320. According to an embodiment, the T-EAS information may include at least one of the T-EAS ID and endpoint information. According to an embodiment, the T-EES information may include at least one of the T-EES ID and endpoint information.

In operation 307, the CCF 320 may include the federated (or bundled) EAS indicator, federated (bundled) EAS(f) API list, and EAS(F) ID through the information received from the S-EAS or the S-EES 310 and transmit the EAS-related API list, in a notification message, to the T-EAS 330.

In operation 309, the CCF 320 may transmit a clean-up message for all S-EAS(f) contexts relocated to the T-EAS 330 to the S-EAS or S-EES 310.

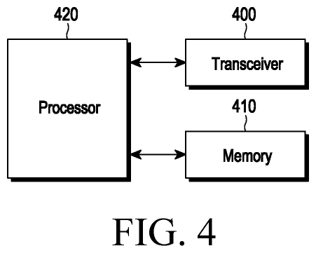

FIG. 4 illustrates a structure of a network device according to various embodiments of the disclosure.

The network device (or network entity) of FIG. 4 may be implemented as any one of the network functions or network devices illustrated in FIG. 1. The network device (or network entity) of FIG. 4 may be implemented as any one of the CCF, S-EAF, S-EAS, S-EES, and T-EAS illustrated in FIGS. 2 and 3.

Referring to FIG. 4, the network device (or network entity) may include a transmission/reception unit (or transceiver), memory, and a control unit (or controller or processor).

The transceiver, controller, and memory of the network device (or network entity) may be operated according to the communication method of the above-described network device (or network entity). However, the components of the network device (or network entity) are not limited to the above-described example. For example, the network device (or network entity) may include more or fewer components than the above-described components. Further, the transceiver, controller, and memory may be implemented in the form of one chip. Further, the controller may include one or more processors.

The receiver of the network device (or network entity) and the transmitter of the network device (or network entity) are collectively referred to as a transceiver, and the transceiver may transmit/receive signals to/from another device. Further, the transceiver may receive a signal through a radio channel, output it to the controller, and transmit a signal output from the controller through the radio channel.

The memory may store programs and data necessary for the operation of the network device (or network entity). Further, the memory may store control information or data that is included in the signal obtained by the network device (or network entity). The memory may include a storage medium, such as ROM, RAM, hard disk, CD-ROM, and DVD, or a combination of storage media. Further, the memory may be included in the controller, rather than being present separately.

The controller may control a series of processes to operate the network device (or network entity) according to the above-described embodiments of the disclosure.

The methods according to the embodiments descried in the specification or claims of the disclosure may be implemented in hardware, software, or a combination of hardware and software.

When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the disclosure.

The programs (software modules or software) may be stored in random access memories, non-volatile memories including flash memories, read-only memories (ROMs), electrically erasable programmable read-only memories (EEPROMs), magnetic disc storage devices, compact-disc ROMs, digital versatile discs (DVDs), or other types of optical storage devices, or magnetic cassettes. Or, the programs may be stored in memory constituted of a combination of all or some thereof. As each constituting memory, multiple ones may be included.

The programs may be stored in attachable storage devices that may be accessed via a communication network, such as the Internet, Intranet, local area network (LAN), wide area network (WAN), or storage area network (SAN) or a communication network configured of a combination thereof. The storage device may connect to the device that performs embodiments of the disclosure via an external port. A separate storage device over the communication network may be connected to the device that performs embodiments of the disclosure.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

Although specific embodiments of the present invention have been described above, various changes may be made thereto without departing from the scope of the present invention. Thus, the scope of the disclosure should not be limited to the above-described embodiments, and should rather be defined by the following claims and equivalents thereof.

1. A method for operation of a common API framework core function (CCF) in a wireless communication system, the method comprising:
receiving a first message related to an application context relocation (ACR) from a source-edge application server (S-EAS) or a source-edge enabler server (S-EES) detecting the ACR of a user equipment (UE); and
transmitting, to a target-EAS (T-EAS), a second message indicating an EAS related to an application programming interface (API) list based on the first message,
wherein the first message includes information about the T-EAS or information about a target-EES (T-EES).

2. The method of claim 1, wherein the second message includes at least one of an indicator for a bundled EAS, an API list related to the bundled EAS, and an ID for the bundled EAS.

3. The method of claim 1, wherein the information about the T-EAS includes at least one of a T-EAS ID and endpoint information, or the information about the T-EES includes at least one of a T-EES ID and endpoint information.

4. The method of claim 1, wherein discovery for the T-EAS is performed by the S-EAS or the S-EES based on an indicator for a bundled EAS.

5. The method of claim 1, further comprising transmitting, to the S-EAS or the S-EES, a message instructing to clean up a context relocated to the T-EAS.

6. A method for operation of a network device in a wireless communication system, the method comprising:
detecting an application context relocation (ACR) of a user equipment (UE); and
transmitting, to a common API framework core function (CCF), a first message related to the ACR and including information about a target-edge application server (T-EAS) or information about a target-edge enabler server (T-EES),
wherein the network device is a source-EAS (S-EAS) or a source-EES (S-EES).

7. The method of claim 6, further comprising performing discovery for the T-EAS based on an indicator for a bundled EAS.

8. The method of claim 6, wherein the information about the T-EAS includes at least one of a T-EAS ID and endpoint information, or the information about the T-EES includes at least one of a T-EES ID and endpoint information.

9. The method of claim 6, further comprising receiving, from the CCF, a message instructing to clean up a context relocated to the T-EAS.

10. A common API framework core function (CCF) device in a wireless communication system, comprising:
a transceiver; and
a controller, wherein the controller is configured to:
receive a first message related to an application context relocation (ACR) from a source-edge application server (S-EAS) or a source-edge enabler server (S-EES) detecting the ACR of a user equipment (UE); and
transmit, to a target-EAS (T-EAS), a second message indicating an EAS related to an application programming interface (API) list based on the first message,
wherein the first message includes information about the T-EAS or information about a target-EES (T-EES).

11. The CCF device of claim 10, wherein the second message includes at least one of an indicator for a bundled EAS, an API list related to the bundled EAS, and an ID for the bundled EAS.

12. The CCF device of claim 10, wherein the information about the T-EAS includes at least one of a T-EAS ID and endpoint information, or the information about the T-EES includes at least one of a T-EES ID and endpoint information.

13. A network device in a wireless communication system, comprising:
a transceiver; and
a controller, wherein the controller is configured to:
detect an application context relocation (ACR) of a user equipment (UE); and
transmit, to a common API framework core function (CCF), a first message related to the ACR and including information about a target-edge application server (T-EAS) or information about a target-edge enabler server (T-EES),
wherein the network entity is a source-EAS (S-EAS) or a source-EES (S-EES).

14. The network device of claim 13, wherein the controller performs discovery for the T-EAS based on an indicator for a bundled EAS.

15. The network device of claim 13, wherein the information about the T-EAS includes at least one of a T-EAS ID and endpoint information, or the information about the T-EES includes at least one of a T-EES ID and endpoint information.
